(19) United States
(12) Patent Application Publication
(10) Pub. No.: US 2020/0089909 A1
(43) Pub. Date: Mar. 19, 2020

(54) PERSONAL INFORMATION PROTECTION DEVICE FOR VEHICLE AND PERSONAL INFORMATION PROTECTION MEHTOD THEREOF AND VEHICLE INCLUDING THE SAME

(71) Applicants: Hyundai Motor Company, Seoul (KR); KIA Motors Corporation, Seoul (KR)

(72) Inventor: Zeung Il Kim, Gyeonggi-do (KR)

(73) Assignees: Hyundai Motor Company, Seoul (KR); KIA Motors Corporation, Seoul (KR)

(21) Appl. No.: 16/189,522

(22) Filed: Nov. 13, 2018

(30) Foreign Application Priority Data
Sep. 17, 2018 (KR) 10-2018-0110709

(51) Int. Cl. G06F 21/62; B60L 11/18; H04L 9/32

(52) U.S. Cl. CPC G06F 21/6245; B60L 11/1838; B60L 2230/16; B60L 11/1851; B60L 2270/38; H04L 9/3263

(57) ABSTRACT

A personal information protection device includes a communication unit connected to control devices of a vehicle for communication, and a controller configured to determine whether to approve data communication of a control device which intends to perform data communication with an outside device. The controller extracts first unique data stored when previous last data communication is performed from a first control device, extracts second unique data stored when previous last data communication is performed from a second control device, determines approval of data communication of the first control device if the extracted pieces of data are consistent with each other, and updates the first unique data on the basis of second unique data acquired at a data communication start time.

### CROSS-REFERENCE TO RELATED APPLICATION

This application claims priority to and the benefit of Korean Patent Application No. 10-2018-0110709, filed on Sep. 17, 2018, the entire contents of which is hereby incorporated by reference as if fully set forth herein.

### FIELD

The present disclosure relates to a personal information protection device for vehicles and, more specifically, to a personal information protection device capable of inhibiting theft and replication of personal information stored in a controller in a vehicle, a personal information protection method thereof and a vehicle including the same.

### BACKGROUND

The statements in this section merely provide background information related to the present disclosure and may not constitute prior art.

As electric vehicles are increasingly propagating, introduction of a plug-and-charge (PnC) function to electric vehicles is promoted for improvement in charging convenience.

The PnC function is a method of performing automatic authentication and charging without intervention of a driver when an electric vehicle is connected to a charger.

However, it may be desirable that the PnC function has robust security technology because personal information (payment method, credit card information, contract information, and the like) of a driver is transmitted/received although convenience is improved.

That is, in an electric vehicle equipped with the PnC function, personal information such as contract information of a client may be stored in a controller in the electric vehicle. If the controller is stolen and mounted in another vehicle, payment using an account of the client having the stolen controller is made when charging for the vehicle having the stolen controller mounted therein is performed may be generated.

Although a communication channel between a charger and an electric vehicle is encrypted and security thereof is maintained through transport layer security (TLS), when a controller is lost, stolen or copied and mounted in other vehicles, a paid service such as charging may be used through a valid contract authentication certificate of the client who lost the controller and the client may be charged for the paid service.

Accordingly, there is a demand for development of a personal information protection device for vehicles capable of inhibiting theft and replication of personal information stored in vehicles such that paid services with respect to external servers can be safely used.

### SUMMARY

The present disclosure describes, in one aspect, a personal information protection device for vehicles, a personal information protection method thereof and a vehicle including the same, which can compare first unique data stored in a control device which intends to perform data communication with an external entity when previous last data communication is performed with second unique data stored in another control device when previous last data communication is performed, determine approval of data communication of the control device if the first unique data is consistent with the second unique data, and update the first unique data of the control device on the basis of second unique data acquired from the other control device at a data communication start time, to thereby inhibit theft and replication of personal information in a vehicle.

In addition, the present disclosure describes a personal information protection device for vehicles, a personal information protection method thereof and a vehicle including the same, which can perform primary security verification of extracting first unique data and second unique data and secondary security verification of comparing the extracted first unique data and second unique data with each other to check whether they are consistent with each other when there is a valid authentication certificate for data communication, to thereby protect personal information in a vehicle safely.

Furthermore, the present disclosure describes a personal information protection device for vehicles, a personal information protection method thereof and a vehicle including the same, which can perform security verification for both internal control devices and external control devices by comparing first unique data extracted from a control device connected to an external entity through communication among control devices of a vehicle or an external control device connected to the vehicle through communication with second unique data extracted from another control device in the vehicle to check whether they are consistent with each other.

Moreover, the present disclosure describes a personal information protection device for vehicles, a personal information protection method thereof and a vehicle including the same, which can extract and record different pieces of unique data according to service types for data communication, thereby allowing utilization of various vehicle services.

In addition, the present disclosure describes a personal information protection device for vehicles, a personal information protection method thereof and a vehicle including the same, which can correctly extract second unique data from a control device without error by identifying the control device which provides first unique data on the basis of an identifier extracted from the first unique data, thereby improving reliability of security verification.

Furthermore, the present disclosure describes a personal information protection device for vehicles, a personal information protection method thereof and a vehicle including the same, which can, when first unique data includes a plurality of pieces of information, determine approval of data communication of a control device if all information included in the first unique data are consistent with all information included in second unique data corresponding thereto, thereby protecting personal information in a vehicle safely.

Moreover, the present disclosure describes a personal information protection device for vehicles, a personal information protection method thereof and a vehicle including the same, which can reject approval of data communication of a control device if first unique data is not consistent with second unique data, generate an approval rejection notification message and transmit the approval rejection notification message to a previously designated entity, to thereby rapidly notify a server and a client that service utilization is blocked, providing user convenience for inhibition of theft and replication of personal information.

A personal information protection device for vehicles according to an aspect of the present disclosure may include: a communication unit connected to control devices of a vehicle for communication; and a controller configured to determine whether to approve data communication of a control device which intends to perform data communication with the outside among the control devices of the vehicle, wherein the controller extracts first unique data stored when previous last data communication is performed from a first control device which intends to perform data communication with the outside if the first control device is present among the control devices of the vehicle, extracts second unique data stored when previous last data communication is performed from a second control device other than the first control device, determines approval of data communication of the first control device if the extracted first unique data is consistent with the extracted second unique data, and updates the first unique data of the first control device on the basis of second unique data acquired from the second control device at a data communication start time.

Here, when the controller extracts the first unique data and the second unique data, the controller may check whether the first control device which intends to perform data communication with the outside is present among the control devices of the vehicle, check whether there is an authentication certificate for data communication if the first control device which intends to perform data communication with the outside is present, and extract the first unique data and the second unique data if there is an authentication certificate.

In addition, when the controller checks whether there is an authentication certificate for data communication, the controller may check whether the authentication certificate is valid if the authentication certificate is present and update the authentication certificate if the authentication certificate is not valid.

Further, when the controller checks whether there is an authentication certificate for data communication, the controller may newly install an authentication certificate if the authentication certificate is not present.

The authentication certificate for data communication may vary according to service types for data communication.

Authentication certificates for data communication may be stored in different control devices according to service types for data communication.

Further, when the controller extracts the first unique data, the controller may check a service type for data communication and extract the first unique data according to the checked service type.

Here, the extracted first unique data may be different according to service types for data communication.

Further, when the controller extracts the second unique data, the controller may identify the second control device which provides the first unique data upon extraction of the first unique data and extract second unique data stored when previous last data communication is performed from the identified second control device.

Here, when the controller identifies the second control device which provides the first unique data, the controller may extract an identifier corresponding to at least one piece of information included in the extracted first unique data and identify the second control device which provides the first unique data on the basis of the extracted identifier.

Further, when the controller determines approval of data communication of the first control device, the controller may check whether all information included in the first unique data are consistent with all information included in second unique data corresponding thereto if the extracted first unique data includes a plurality of pieces of information, and determine approval of data communication of the first control device when all information included in the first unique data are consistent with all information included in second unique data corresponding thereto.

Here, when the controller checks whether all information included in the first unique data are consistent with all information included in second unique data corresponding thereto, the controller may reject approval of data communication of the first control device, generate an approval rejection notification message and transmit the approval rejection notification message to a previously designated entity if all information included in the first unique data are not consistent with all information included in second unique data corresponding thereto

Further, when the controller updates the first unique data of the first control device, the controller may acquire second unique data corresponding to a data communication start time from the second control device upon determination of approval of data communication of the first control device, and update the first unique data of the first control device on the basis of the acquired second unique data.

In one aspect, a personal information protection method of a personal information protection device for vehicles including a communication unit connected to control devices of a vehicle for communication, and a controller configured to determine whether to approve data communication of a control device which intends to perform data communication with the outside among the control devices of the vehicle may include: the controller checking whether a first control device which intends to perform data communication with the outside is present among the control devices of the vehicle through the communication unit; the controller extracting first unique data stored when previous last data communication is performed from the first control device when the first control device which intends to perform data communication with the outside is present; the controller extracting second unique data stored when previous last data communication is performed from a second control device other than the first control device; the controller checking whether the extracted first unique data is consistent with the extracted second unique data; the controller determining approval of data communication of the first control device if the extracted first unique data is consistent with the extracted second unique data; the controller acquiring second unique data corresponding to a data communication start time from the second control device upon determination of approval of data communication of the first control device; and the controller updating the first unique data of the first control device on the basis of the acquired second unique data.

In one aspect, a personal information protection method of a personal information protection device for vehicles including a controller configured to determine whether to approve data communication of a charging control device which intends to perform data communication with an external charger may include: the controller checking whether the charging control device of a vehicle is connected to an external charger for data communication; the controller checking whether there is an authentication certificate related to a vehicle charging service when the charging control device of the vehicle is connected to an external charger for data communication; the controller extracting first unique data stored when previous last data communication is performed from the charging control device when the authentication certificate is present; the controller extracting second unique data stored when previous last data communication is performed from a control device other than the charging control device; the controller checking whether the extracted first unique data is consistent with the extracted second unique data; the controller determining that the current state is a normal condition and determining approval of data communication of the charging control device if the extracted first unique data is consistent with the extracted second unique data; the controller acquiring second unique data from the control device other than the charging control device upon determination of approval of data communication of the charging control device; the controller updating the first unique data of the charging control device on the basis of the acquired second unique data; and the controller controlling the charging control device to perform data communication with the external charger to start charging when the first unique data has been updated.

Further, a computer readable recording medium storing a program for executing the personal information protection method of a personal information protection device for vehicles according to an aspect of the present disclosure may perform processes provided by the personal information protection method.

In addition, a vehicle according to an aspect of the present disclosure may include a plurality of control devices connected through communication and a personal information protection device for determining whether to approve data communication of a control device which intends to perform data communication with the outside among the plurality of control devices, wherein the personal information protection device extracts first unique data stored when previous last data communication is performed from a first control device which intends to perform data communication with the outside if the first control device is present among the plurality of control devices, extracts second unique data stored when previous last data communication is performed from a second control device other than the first control device, determines approval of data communication of the first control device if the extracted first unique data is consistent with the extracted second unique data, and updates the first unique data of the first control device on the basis of second unique data acquired from the second control device at a data communication start time.

The personal information protection device for vehicles, the personal information protection method thereof and the vehicle including the same configured as described above according to at least one aspect of the present disclosure can compare first unique data stored in a control device which intends to perform data communication with an external entity when previous last data communication is performed with second unique data stored in another control device when previous last data communication is performed, determine approval of data communication of the control device if the first unique data is consistent with the second unique data, and update the first unique data of the control device on the basis of second unique data acquired from the other control device at a data communication start time, to thereby inhibit theft and replication of personal information in a vehicle.

In addition, system and/or method according to the present disclosure can perform primary security verification of extracting first unique data and second unique data and secondary security verification of comparing the extracted first unique data and second unique data with each other to check whether they are consistent with each other when there is a valid authentication certificate for data communication, to thereby protect personal information in a vehicle safely.

Furthermore, a system and/or method according to the present disclosure can perform security verification for both internal control devices and external control devices by comparing first unique data extracted from a control device connected to an external entity through communication among control devices of a vehicle or an external control device connected to the vehicle through communication with second unique data extracted from another control device in the vehicle to check whether they are consistent with each other.

Moreover, a system and/or method according to the present disclosure can extract and record different pieces of unique data according to service types for data communication, thereby allowing utilization of various vehicle services.

In addition, a system and/or method according to the present disclosure can correctly extract second unique data from a control device without error by identifying the control device which provides first unique data on the basis of an identifier extracted from the first unique data, thereby improving reliability of security verification.

Furthermore, a system and/or method according to the present disclosure can, when first unique data includes a plurality of pieces of information, determine approval of data communication of a control device if all information included in the first unique data are consistent with all information included in second unique data corresponding thereto, thereby protecting personal information in a vehicle safely.

Moreover, a system and/or method according to the present disclosure can reject approval of data communication of a control device if first unique data is not consistent with second unique data, generate an approval rejection notification message and transmit the approval rejection notification message to a previously designated entity, to thereby rapidly notify a server and a client that service utilization is blocked, providing user convenience for inhibition of theft and replication of personal information.

Further, considering the trend toward an increasing number of vehicle controllers connected to external infrastructure, such as a PnC controller, a system and/or method according to the present disclosure can provide a fundamental countermeasure against theft/replication of controllers.

Further, a system and/or method according to the present disclosure can realize a system without additional packages or parts.

In addition, a system and/or method according to the present disclosure can inhibit information from being taken according to signal capture by allocating one byte to a CAN signal and transmitting final storage information only when a new PnC service is started.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIGS. 1 and 2 are block diagrams for describing a vehicle including a personal information protection device for vehicles;

FIG. 3 is a block diagram for describing a configuration of the personal information protection device of FIG. 1;

FIG. 4 is a block diagram for describing use of a charging service by a vehicle including the personal information protection device for vehicles;

FIG. 5 is a diagram for describing an authentication certificate installation process according to the charging service of FIG. 4; and

FIG. 6 is a flowchart for describing a personal information protection method of the personal information protection device for vehicles.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Throughout the specification, the term “includes” should be interpreted not to exclude other elements but to further include such other elements since the corresponding elements may be included unless mentioned otherwise. In addition, the terms “part”, “-er(or)” or “module” are used to signify a unit of performing at least one function or operation and can be realized in hardware, software, or in combination of both.

Throughout the specification, the term “includes” should be interpreted not to exclude other elements but to further include such other elements since the corresponding elements may be included unless mentioned otherwise. Further, the same reference numbers will be used throughout this specification to refer to the same or like parts.

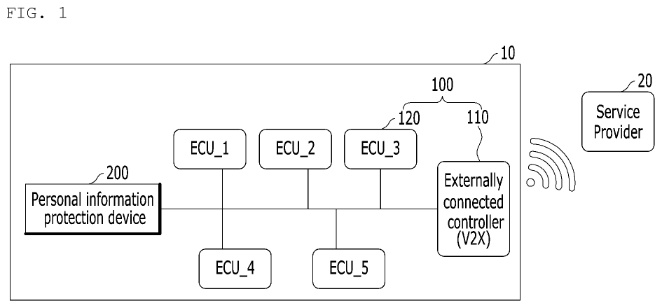

Hereinafter, a personal information protection device for vehicles, a personal information protection method thereof, and a vehicle including the same applicable to aspects of the present disclosure will be described with reference to FIGS. 1 to 6.

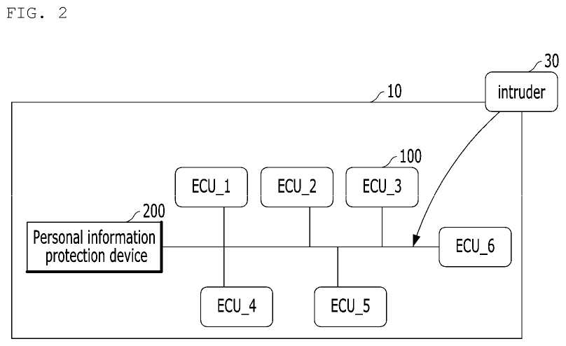

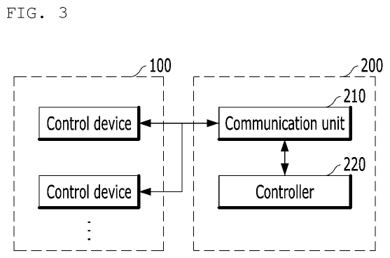

FIGS. 1 and 2 are block diagrams for describing a vehicle including a personal information protection device for vehicles according to an aspect of the present disclosure and FIG. 3 is a block diagram for describing a configuration of the personal information protection device of FIG. 1.

As shown in FIGS. 1 and 2, the vehicle 10 including a personal information protection device for vehicles may include a plurality of control devices 100 connected for communication, and a personal information protection device 200 which determines whether to approve data communication of a control device which will perform data communication with the outside among the plurality of control devices 100.

Here, the plurality of control devices 100 may perform CAN communication through a network in the vehicle 10.

In addition, the plurality of control devices 100 may include a first control device 110 which will perform data communication with external entities and a second control device 120 other than the first control device 110.

For example, the first control device 110 may be a control device connected to an external entity among the control devices 100 of the vehicle 10, as shown in FIG. 110, or an external control device connected to the vehicle 10 through communication, as shown in FIG. 2.

Here, external entities may be various devices capable of performing communication, such as external servers, external vehicles and external terminals, and may be a service provider server 20 as shown in FIG. 1 or an external control device 30 which is connected to a network of a vehicle for data communication or intrudes into a network of a vehicle in order to capture data of the vehicle, as shown in FIG. 2.

Accordingly, aspects of the present disclosure can inhibit leakage, replication and theft of personal information in a vehicle by verifying data communication with such external entities and approving or rejecting data communication through the personal information protection device 200.

The personal information protection device 200 may extract first unique data stored when previous last data communication is performed from the first control device 110 when the first control device 110 which will perform data communication with an external entity is present among the plurality of control devices 100, extract second unique data stored when previous last data communication is performed from the second control device 120 other than the first control device 110, determines approval of data communication of the first control device 110 when the extracted first unique data and second unique data are consistent with each other, and update the first unique data of the first control device 110 on the basis of second unique data acquired from the second control device 120 at a data communication start time.

For example, the vehicle having the personal information protection device 200 as shown in FIG. 1 may download a service (music, video or the like) through a radio channel, distribute and store last downloaded data in controllers connected to a vehicle network, and then compare data distributed and stored in the controllers when the service is resumed to secure integrity of a controller connected to an external entity.

Alternatively, the vehicle having the personal information protection device 200 as shown in FIG. 2 may distribute and store integrity values (checksum information) with respect to data of mass-produced controllers for providing network security in the vehicle, and then compare the distributed and stored integrity values when an external controller is connected or intrudes to verify security of the external controller.

Further, the personal information protection device 200 for vehicles may include a communication unit 210 connected to the control devices 100 of the vehicle 20 for communication, and a controller 220 which determines whether to approve data communication of a control device which will perform data communication with an external entity among the control devices 100 of the vehicle 10.

Here, the controller 220 may extract first unique data stored when previous last data communication is performed from the first control device 110 when the first control device 110 which will perform data communication with an external entity is present among the plurality of control devices 100 of the vehicle 10, extract second unique data stored when previous last data communication is performed from the second control device 120 other than the first control device 110, determine approval of data communication of the first control device 110 when the extracted first unique data and second unique data are consistent with each other, and update the first unique data of the first control device 110 on the basis of second unique data acquired from the second control device 120 at a data communication start time.

For example, the communication unit 210 may perform CAN communication with the control devices 100 of the vehicle 10 through an internal network of the vehicle 10.

In addition, the controller 220 may check whether the first control device 110 which will perform data communication with an external entity is present among the control devices 100 of the vehicle 10 when the first unique data and the second unique data are extracted, check whether there is an authentication certificate for data communication when the first control device 110 which will perform data communication with an external entity is present, and extract the first unique data and the second unique data when the authentication certificate is present.

Here, the controller 220 may recognize, as the first control device 110, a control device connected to an external entity through communication among the control devices 100 of the vehicle 10 when checking whether the first control device 110 which will perform data communication with an external entity is present.

The controller 220 may recognize an external control device connected to the vehicle 10 through communication as the first control device 110 when checking whether the first control device 110 which will perform data communication with an external entity is present.

Further, when the controller 220 checks whether there is an authentication certificate for data communication, the controller 220 checks whether the authentication certificate is valid when there is the authentication certificate and update the authentication certificate when the authentication certificate is not valid.

In addition, when the controller 220 checks whether there is an authentication certificate for data communication, the controller 220 may newly install an authentication certificate when there is no authentication certificate.

Here, the authentication certificate for data communication may vary according to service types for data communication.

For example, the authentication certificate for data communication may be at least one of a first authentication certificate for data communication with respect to a vehicle charging service, a second authentication certificate for data communication with respect to a vehicle diagnosis service, and a third authentication certificate for data communication with respect to a music and video service.

Authentication certificates for data communication may be stored in different control devices according to service types for data communication.

Regarding authentication certificates for data communication, for example, a first authentication certificate for data communication related to a vehicle charging service may be stored in a vehicle charging control device, a second authentication certificate for data communication related to a vehicle diagnosis service may be stored in a vehicle diagnosis control device, and a third authentication certificate for data communication related to a music and video service may be stored in a music and video control device.

In addition, when the controller 220 extracts first unique data, the controller 220 may check a service type for data communication and extract first unique data according to the checked service type.

Here, the extracted first unique data may be different according to service types for data communication.

For example, when the controller 220 extracts first unique data according to the checked service type, the controller 220 may extract first unique data including vehicle charging state information, driving record information, time information and global positioning system (GPS) information of the vehicle when the service type is the vehicle charging service.

Here, the vehicle charging state information may be first unique data acquired from a battery related control device among control devices in the vehicle, the driving record information of the vehicle may be first unique data acquired from a driving record related control device among the control devices in the vehicle, and the time information and GPS information of the vehicle may be first unique data acquired from a navigation related control device among the control devices in the vehicle.

As another example, when the controller 220 extracts first unique data according to the checked service type, the controller 220 may extract first unique data including vehicle diagnostic trouble code (DTC) information, diagnosed control device information, time information and GPS information of the vehicle when the service type is the vehicle diagnosis service.

Here, the diagnostic trouble code information of the vehicle may be first unique data acquired from a wireless communication related control device among the control devices in the vehicle, the diagnosed control device information may be first unique data acquired from a diagnosed control device among the control devices in the vehicle, and the time information and GPS information of the vehicle may be first unique data acquired from a navigation related control device among the control devices in the vehicle.

As another example, when the controller 220 extracts first unique data according to the checked service type, the controller 220 may extract first unique data including checksum information about data finally downloaded when previous last data communication is performed if the service type is the music and video service.

Here, the checksum information about the finally downloaded data may be first unique data acquired from a wireless communication related control device and an audio and video related control device among the control devices in the vehicle.

In addition, when the controller 220 extracts second unique data, the controller 220 may identify a second control device which provides first unique data upon extraction of the first unique data and extract second unique data stored when previous last data communication is performed from the identified second control device.

Here, the controller 220 may extract an identifier corresponding to at least one piece of information included in the extracted first unique data when identifying the second control device which provides the first unique data and identifies the second control device which provides the first unique data on the basis of the extracted identifier.

Here, when the controller 220 extracts the identifier from the first unique data, if the first unique data includes a plurality of pieces of information, different identifiers may correspond to the plurality of pieces of information. However, the present disclosure is not limited thereto.

For example, when the controller 220 identifies the second control device which provides the first unique data, the controller 220 may extract an identifier corresponding to vehicle charging state information, an identifier corresponding to vehicle driving record information, an identifier corresponding to vehicle time information and an identifier corresponding to vehicle GPS information if the extracted first unique data includes the charging state information, driving record information, time information and GPS information of the vehicle and identify the second control device which provides the first unique data on the basis of the extracted identifiers.

Here, the identifier corresponding to the vehicle charging state information is an identification factor for a battery related control device which has provided the vehicle charging state information, the identifier corresponding to the vehicle driving record information may be an identification factor for a driving record related control device which has provided the vehicle driving record information, and the identifiers corresponding to the time information and the GPS information of the vehicle may be identification factors for a navigation related control device which has provided the time information and GPS information of the vehicle.

As another example, when the controller 220 identifies the second control device which provides the first unique data, the controller 220 may extract an identifier corresponding to vehicle DTC information, an identifier corresponding to diagnosed control device information of the vehicle, an identifier corresponding to time information and an identifier corresponding to GPS information if the extracted first unique data includes the DTC information, diagnosed control device information, time information and GPS information of the vehicle and identify the second control device which provides the first unique data on the basis of the extracted identifiers.

Here, the identifier corresponding to the vehicle DTC information may be an identification factor for a wireless communication related control device which has provided the vehicle DTC information, the identifier corresponding to the diagnosed control device information of the vehicle may be an identification factor for the diagnosed control device which has provided the diagnosed control device information of the vehicle, and the identifiers corresponding to the time information and the GPS information of the vehicle may be identification factors for a navigation related control device which has provided the time information and GPS information of the vehicle.

As another example, when the controller 220 identifies the second control device which provides the first unique data, if the extracted first unique data includes checksum information about data finally downloaded when previous last data communication is performed, the controller 220 may extract an identifier corresponding to the checksum information and identify the second control device which provides the first unique data on the basis of the extracted identifier.

Here, the identifier corresponding to the checksum information may be an identification factor for a wireless communication related control device or an audio and video related control device which has provided the checksum information.

Subsequently, when the controller 220 determines approval of data communication of the first control device, the controller 220 may check whether all information included in the extracted first unique data are consistent with all information included in the second unique data corresponding thereto if the extracted first unique data includes a plurality of pieces of information and determine approval of data communication of the first control device if all information included in the extracted first unique data are consistent with all information included in the second unique data corresponding thereto.

Here, if all information included in the extracted first unique data are not consistent with all information included in the second unique data corresponding thereto, the controller 220 may reject approval of data communication of the first control device, generate an approval rejection notification message and transmit the approval rejection notification message to a previously designated entity.

For example, the previously designated entity may be at least one of an internal display device of the vehicle, an external server, other vehicles, and an external terminal but is not limited thereto.

In addition, when the controller 220 updates the first unique data of the first control device, the controller 220 may acquire second unique data corresponding to a data communication start time from the second control device upon determination of approval of data communication of the first control device, and update the first unique data of the first control device on the basis of the acquired second unique data.

For example, when the controller 220 acquires second unique data corresponding to a data communication start time from the second control device, the controller 220 may acquire second unique data including charging state information, driving record information, time information and GPS information of the vehicle corresponding to the data communication start time if approved data communication is vehicle charging service related data communication.

Here, the controller 220 may acquire second unique data including the vehicle charging state information from a battery related control device among the control devices in the vehicle, acquire second unique data including the vehicle driving record information from a driving record related control device among the control devices in the vehicle, and acquire second unique data including the time information and GPS information of the vehicle from a navigation related control device among the control devices in the vehicle.

As another example, when the controller 220 acquires second unique data corresponding to a data communication start time from the second control device, the controller 220 may acquire second unique data including DTC information, diagnosed control device information, time information and GPS information of the vehicle if approved data communication is vehicle diagnosis service related data communication.

Here, the controller 220 may acquire second unique data including the DTC information of the vehicle from a wireless communication related control device among the control devices in the vehicle, acquire second unique data including the diagnosed control device information from the diagnosed control device among the control devices in the vehicle, and acquire second unique data including the time information and GPS information of the vehicle from a navigation related control device among the control devices in the vehicle.

As another example, when the controller 220 acquires second unique data corresponding to a data communication start time from the second control device, the controller 220 may acquire second unique data including checksum information about data finally downloaded at the data communication start time if approved data communication is music and video service related data communication.

Here, the controller 220 may acquire second unique data including the checksum information about the finally downloaded data from a wireless communication related control device or an audio and video related control device among the control devices in the vehicle.

As described above, a system and/or method according to the present disclosure can compare first unique data stored in a control device which intends to perform data communication with an external entity when previous last data communication is performed with second unique data stored in another control device when previous last data communication is performed, determine approval of data communication of the control device if the first unique data is consistent with the second unique data, and update the first unique data of the control device on the basis of second unique data acquired from the other control device at a data communication start time, to thereby inhibit theft and replication of personal information in a vehicle.

In addition, the present system and method can perform primary security verification of extracting first unique data and second unique data and secondary security verification of comparing the extracted first unique data and second unique data with each other to check whether they are consistent with each other when there is a valid authentication certificate for data communication, to thereby protect personal information in a vehicle safely.

Furthermore, the present system and method can perform security verification for both internal control devices and external control devices by comparing first unique data extracted from a control device connected to an external entity through communication among control devices of a vehicle or an external control device connected to the vehicle through communication with second unique data extracted from another control device in the vehicle to check whether they are consistent with each other.

Moreover, the present system and method can extract and record different pieces of unique data according to service types for data communication, thereby allowing utilization of various vehicle services.

In addition, the present system and method can correctly extract second unique data from a control device without error by identifying the control device which provides first unique data on the basis of an identifier extracted from the first unique data, thereby improving reliability of security verification.

Furthermore, when first unique data includes a plurality of pieces of information, the present system and method can determine approval of data communication of a control device if all information included in the first unique data are consistent with all information included in second unique data corresponding thereto, thereby protecting personal information in a vehicle safely.

Moreover, the present system and method can reject approval of data communication of a control device if first unique data is not consistent with second unique data, generate an approval rejection notification message and transmit the approval rejection notification message to a previously designated entity, to thereby rapidly notify a server and a client that service utilization is blocked, providing user convenience for inhibition of theft and replication of personal information.

Further, considering the trend toward an increasing number of vehicle controllers connected to external infrastructure, such as a PnC controller, the present system and method can provide a fundamental countermeasure against theft/replication of controllers.

Further, the present disclosure describes a system without additional package or parts.

In addition, the present system and method can inhibit information from being taken according to signal capture by allocating one byte to a CAN signal and transmitting final storage information only when a new PnC service is started.

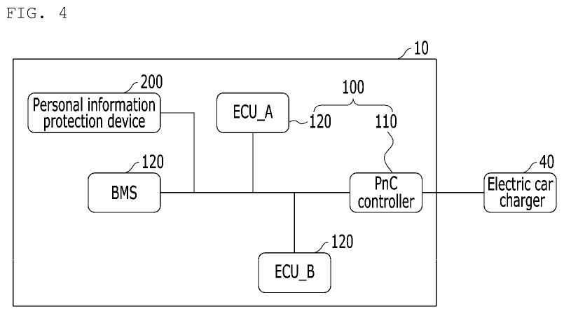

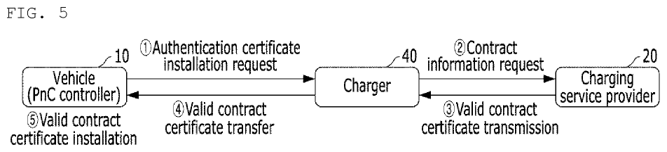

FIG. 4 is a block diagram for describing use of a charging service by a vehicle including the personal information protection device for vehicles according to an aspect of the present disclosure and FIG. 5 is a diagram for describing an authentication certificate installation process according to the charging service of FIG. 4.

As shown in FIGS. 4 and 5, a vehicle 10 including the personal information protection device can support a PnC function when using a charging service.

Here, an electric vehicle supporting the PnC function is equipped with a PnC controller having a vehicle certificate and an authentication certificate for a contract with a charging service provider installed therein and thus can be connected to external chargers to perform vehicle charging through procedures such as automatic authentication and charging.

Here, a communication channel between the vehicle 10 and a charger 40 may be encrypted.

In addition, the vehicle 10 including the personal information protection device may include a plurality of control devices 100 connected to each other, and the personal information protection device 200 which determines whether to approve data communication of a charging control device which intends to perform data communication with the external charger 40 among the plurality of control devices 100.

Here, the plurality of control devices 100 can perform CAN communication through a network inside of the vehicle 10.

In addition, the plurality of control devices 100 may include a first control device 110 which intends to perform data communication with the charger 40 and a second control device 120 other than the first control device 110.

The personal information protection device 200 may extract, when there is the first control device 110 which intends to perform data communication with the charger 40 among the plurality of control devices 100, first unique data stored when previous last data communication is performed from the first control device 110, extract second unique data stored when previous last data communication is performed from the second control device 120 other than the first control device 110, determine approval of data communication of the first control device 110 if the extracted first unique data and second unique data are consistent with each other, and update the first unique data of the first control device 110 on the basis of second unique data acquired from the second control device at a data communication start time.

Here, when the personal information protection device 200 extracts first unique data and second unique data, the personal information protection device 200 may check whether there is the first control device 110 which intends to perform data communication with the charger 40 among the control devices 100 of the vehicle 10, checks whether there is an authentication certificate for data communication when there is the control device 110 which intends to perform data communication with the charger 40, and extract the first unique data and the second unique data if there is the authentication certificate.

Further, when the personal information protection device 200 checks whether there is an authentication certificate for data communication, the personal information protection device 200 may check whether the authentication certificate is valid when there is the authentication certificate and update the authentication certificate when the authentication certificate is not valid.

In addition, when the personal information protection device 200 checks whether there is an authentication certificate for data communication, the personal information protection device 200 may newly install an authentication certificate when there is no authentication certificate.

Here, an authentication certificate for data communication may be an authentication certificate for data communication related to a vehicle charging service but is not limited thereto.

For example, as shown in FIG. 5, the personal information protection device 200 may send a request for authentication certification installation to the charger 40 when there is no authentication certificate, the charger 40 may send a request for a contract with respect to a charging service to a server 20 of a charging service provider, the server 20 of the charging service provider may transmit a valid contract certificate to the charger 40, the charger 40 may transmit the valid contract certificate to the charging control device of the vehicle 10, and the charging control device of the vehicle 10 may newly install the valid contract certificate.

Subsequently, the personal information protection device 200 may extract first unique data including charging state information, driving record information, time information and GPS information of the vehicle from the first control device 110 in the case of the vehicle charging service.

Here, the charging state information of the vehicle may be first unique data acquired from a battery related control device among the control devices of the vehicle, the driving record information of the vehicle may be first unique data acquired from a driving record related control device among the control devices of the vehicle, and the time information and GPS information of the vehicle may be first unique data acquired from a navigation related control device among the control devices of the vehicle.

Subsequently, the personal information protection device 200 may identify the second control device 120 which provides the first unique data upon extraction of the first unique data, and extract second unique data stored when previous last data communication is performed from the identified second control device 120.

Here, when the personal information protection device 200 identifies the second control device 120 which provides the first unique data, the personal information protection device 200 may extract an identifier corresponding to at least one information included in the extracted first unique data and identify the second control device 120 which provides the first unique data on the basis of the extracted identifier.

For example, when the personal information protection device 200 identifies the second control device, the personal information protection device 200 may extract an identifier corresponding to charging state information of the vehicle, an identifier corresponding to driving record information of the vehicle, an identifier corresponding to time information of the vehicle and an identifier corresponding to GPS information of the vehicle when the extracted first unique data includes the charging state information, driving record information, time information and GPS information of the vehicle and identify the second control device which provides the first unique data on the basis of the extracted identifiers.

Here, the identifier corresponding to charging state information of the vehicle may be an identification factor for a battery related control device which has provided the charging state information of the vehicle, the identifier corresponding to driving record information of the vehicle may be an identification factor for a driving record related control device which has provided the driving record information of the vehicle, and the identifiers corresponding to time information and GPS information of the vehicle may be identification factors for a navigation related control device which has provided the time information and GPS information of the vehicle.

Subsequently, when the personal information protection device 200 determines approval of data communication of the first control device 110, the personal information protection device 200 may check whether all information included in the extracted first unique data are consistent with all information included in second unique data corresponding thereto if the first unique data includes a plurality of pieces of information and determine approval of data communication of the first control device 110 when all information included in the extracted first unique data are consistent with all information included in the second unique data.

Here, when the personal information protection device 200 checks whether all information included in the extracted first unique data is consistent with all information included in second unique data corresponding thereto, the personal information protection device 200 may reject approval of data communication of the first control device, generate an approval rejection notification message and transmit the approval rejection notification message to a previously designated entity if all information included in the extracted first unique data is not consistent with all information included in second unique data corresponding thereto.

For example, the previously designated entity may be at least one of an internal display device of the vehicle, an external server, other vehicles and an external terminal but is not limited thereto.

In addition, when the personal information protection device 200 updates the first unique data of the first control device 110, the personal information protection device 200 may acquire second unique data corresponding to a data communication start time from the second control device 120 upon determination of approval of data communication of the first control device 110 and update the first unique data of the first control device 110.

For example, when the personal information protection device 200 acquires second unique data corresponding to a data communication start time from the second control device 120, the personal information protection device 200 may acquire second unique data including charging state information, driving record information, time information and GPS information of the vehicle which correspond to the data communication start time when approved data communication is vehicle charging service related data communication.

Here, the personal information protection device 200 may acquire second unique data including the charging state information of the vehicle from a battery related control device among the control devices in the vehicle, acquire second unique data including the driving record information of the vehicle from a driving record related control device among the control devices in the vehicle, and acquire second unique data including the time information and GPS information of the vehicle from a navigation related control device among the control devices in the vehicle.

In general, the current vehicle internal network is CAN and has no security function.

The PnC function is executed in such a manner that, when a vehicle OEM releases electric cars equipped with an OEM Root certificate, a contract for charging is made with a charging service provider which is a client and a valid contract certificate is installed in a PnC controller of a vehicle through a charger during initial charging of the vehicle.

Thereafter, authentication/charging is automatically performed without intervention of a user upon connection of the vehicle to a charger because the contract certificate has been installed in the vehicle.

That is, encrypted security communication is performed between a vehicle and a charger and between a charger and a charging service provider, and a vehicle which has received a valid contract certificate can install the certificate in a controller (referred to as a PnC controller) thereof.

However, when the PnC controller is replicated or stolen and mounted in other vehicles, the valid certificate installed in the controller may be used in other vehicles.

Accordingly, one aspect of the present disclosure distributes unique information on a vehicle to controllers in the vehicle and compares previous data values of controllers when the PnC function is started to determine whether a corresponding controller is a stolen controller, to thereby reinforce security.

In the present disclosure, controllers in a vehicle share information such as odometer, state of charge (SOC), time (last charging start time), and GPS (last charging start position) of last charging initiation condition.

Odo, SOC, time and GPS data immediately before last charging cannot be replicated because they are recorded in a vehicle as unique information.

The PnC controller compares unique data with unique data of other controllers which share the unique data when connected to a charger to attempt charging.

Here, if there is a stolen or replicated controller, unique data including odometer, SOC and time information of the controller is not consistent with the unique data of the PnC controller.

In this case, the present system and/or method performs automatic theft notification by notifying an external network of the unique data inconsistency through the charger such that charging is not performed.

In addition, when the PnC controller has no certificate or a certificate that has expired, the present system and/or method installs an updated or new certificate through a charger without performing the above-described verification procedure and thus can eliminate the possibility that the previous certificate can be used.

In this manner, the present system and/or method can protect personal information in a vehicle through the verification procedure when various services including the charging service are used.

A description will be given of a personal information protection method of a personal information protection device for vehicles which includes a communication unit connected to control devices of a vehicle through communication and a controller which determines approval of data communication of a control device which intends to perform data communication with an external entity among the control devices of the vehicle.

First, the controller of the personal information protection device may check whether there is a first control device which intends to perform data communication with an external entity among the control devices of the vehicle through the communication unit.

Subsequently, the controller may extract first unique data stored when previous last data communication is performed from the first control device if there is the first control device which intends to perform data communication with an external entity.

Here, when the controller extracts the first unique data stored when previous last data communication is performed from the first control device, the controller may check whether there is the first control device which intends to perform data communication with an external entity among the control devices of the vehicle, check whether there is an authentication certificate for data communication when there is the first control device which intends to perform data communication with an external entity, and extract the first unique data stored when previous last data communication is performed from the first control device when there is the authentication certificate.

Here, when the controller checks whether there is an authentication certificate for data communication, the controller may check whether the authentication certificate is valid when there is the authentication certificate and update the authentication certificate when the authenticate certificate is not valid.

When the controller checks whether there is an authentication certificate for data communication, the controller may newly install an authentication certificate when there is no authentication certificate.

Here, the authentication certificate for data communication may vary according to service types for data communication.

For example, the authentication certificate for data communication may be at least one of a first authentication certificate for data communication with respect to a vehicle charging service, a second authentication certificate for data communication with respect to a vehicle diagnosis service, and a third authentication certificate for data communication with respect to a music and video service.

In addition, authentication certificates for data communication may be stored in different control devices according to service types for data communication.

Regarding authentication certificates for data communication, for example, a first authentication certificate for data communication related to a vehicle charging service may be stored in a vehicle charging control device, a second authentication certificate for data communication related to a vehicle diagnosis service may be stored in a vehicle diagnosis control device, and a third authentication certificate for data communication related to a music and video service may be stored in a music and video control device.

In addition, when the controller extracts first unique data stored when previous last data communication is performed, the controller may check a service type for data communication and extract first unique data according to the checked service type.

For example, when the controller extracts first unique data according to the checked service type, the controller may extract first unique data including vehicle charging state information, driving record information, time information and global positioning system (GPS) information of the vehicle when the service type is the vehicle charging service.

Here, the vehicle charging state information may be first unique data acquired from a battery related control device among control devices in the vehicle, the driving record information of the vehicle may be first unique data acquired from a driving record related control device among the control devices in the vehicle, and the time information and GPS information of the vehicle may be first unique data acquired from a navigation related control device among the control devices in the vehicle.

As another example, when the controller extracts first unique data according to the checked service type, the controller may extract first unique data including vehicle diagnostic trouble code (DTC) information, diagnosed control device information, time information and GPS information of the vehicle when the service type is the vehicle diagnosis service.

Here, the diagnostic trouble code information of the vehicle may be first unique data acquired from a wireless communication related control device among the control devices in the vehicle, the diagnosed control device information may be first unique data acquired from a diagnosed control device among the control devices in the vehicle, and the time information and GPS information of the vehicle may be first unique data acquired from a navigation related control device among the control devices in the vehicle.

As another example, when the controller extracts first unique data according to the checked service type, the controller may extract first unique data including checksum information about data finally downloaded when previous last data communication is performed if the service type is the music and video service.

Here, the checksum information about the finally downloaded data may be first unique data acquired from a wireless communication related control device and an audio and video related control device among the control devices in the vehicle.

Subsequently, the controller may extract second unique data stored when previous last data communication is performed from a second control device other than the first control device.

That is, when the controller extracts second unique data, the controller may identify a second control device which provides first unique data upon extraction of the first unique data and extract second unique data stored when previous last data communication is performed from the identified second control device.

Here, the controller may extract an identifier corresponding to at least one piece of information included in the extracted first unique data when identifying the second control device which provides the first unique data and identifies the second control device which provides the first unique data on the basis of the extracted identifier.

Here, when the controller extracts the identifier from the first unique data, if the first unique data includes a plurality of pieces of information, different identifiers may correspond to the plurality of pieces of information. However, the system and/or method of the present disclosure is not limited thereto.

For example, when the controller identifies the second control device which provides the first unique data, the controller may extract an identifier corresponding to vehicle charging state information, an identifier corresponding to vehicle driving record information, an identifier corresponding to vehicle time information and an identifier corresponding to vehicle GPS information if the extracted first unique data includes the charging state information, driving record information, time information and GPS information of the vehicle and identify the second control device which provides the first unique data on the basis of the extracted identifiers.

Here, the identifier corresponding to the vehicle charging state information is an identification factor for a battery related control device which has provided the vehicle charging state information, the identifier corresponding to the vehicle driving record information may be an identification factor for a driving record related control device which has provided the vehicle driving record information, and the identifiers corresponding to the time information and the GPS information of the vehicle may be identification factors for a navigation related control device which has provided the time information and GPS information of the vehicle.

As another example, when the controller identifies the second control device which provides the first unique data, the controller may extract an identifier corresponding to vehicle DTC information, an identifier corresponding to diagnosed control device information of the vehicle, an identifier corresponding to time information and an identifier corresponding to GPS information if the extracted first unique data includes the DTC information, diagnosed control device information, time information and GPS information of the vehicle and identify the second control device which provides the first unique data on the basis of the extracted identifiers.

Here, the identifier corresponding to the vehicle DTC information may be an identification factor for a wireless communication related control device which has provided the vehicle DTC information, the identifier corresponding to the diagnosed control device information of the vehicle may be an identification factor for the diagnosed control device which has provided the diagnosed control device information of the vehicle, and the identifiers corresponding to the time information and the GPS information of the vehicle may be identification factors for a navigation related control device which has provided the time information and GPS information of the vehicle.

As another example, when the controller identifies the second control device which provides the first unique data, if the extracted first unique data includes checksum information about data finally downloaded when previous last data communication is performed, the controller may extract an identifier corresponding to the checksum information and identify the second control device which provides the first unique data on the basis of the extracted identifier.

Here, the identifier corresponding to the checksum information may be an identification factor for a wireless communication related control device or an audio and video related control device which has provided the checksum information.

Subsequently, the controller may check whether the extracted first unique data is consistent with the extracted second unique data and determine approval of data communication of the first control device when the extracted first unique data is consistent with the extracted second unique data.

Here, when the controller determines approval of data communication of the first control device, the controller may check whether all information included in the extracted first unique data are consistent with all information included in the second unique data corresponding thereto if the extracted first unique data includes a plurality of pieces of information and determine approval of data communication of the first control device if all information included in the extracted first unique data are consistent with all information included in the second unique data corresponding thereto.

Here, if all information included in the extracted first unique data are not consistent with all information included in the second unique data corresponding thereto, the controller may reject approval of data communication of the first control device, generate an approval rejection notification message and transmit the approval rejection notification message to a previously designated entity.

For example, the previously designated entity may be at least one of an internal display device of the vehicle, an external server, other vehicles, and an external terminal but is not limited thereto.

Subsequently, the controller may acquire second unique data corresponding to a data communication start time from the second control device upon determination of approval of data communication of the first control device and update the first unique data of the first control device on the basis of the acquired second unique data.

Here, when the controller updates the first unique data of the first control device, the controller may acquire second unique data corresponding to a data communication start time from the second control device upon determination of approval of data communication of the first control device, and update the first unique data of the first control device on the basis of the acquired second unique data.

For example, when the controller acquires second unique data corresponding to a data communication start time from the second control device, the controller may acquire second unique data including charging state information, driving record information, time information and GPS information of the vehicle corresponding to the data communication start time if approved data communication is vehicle charging service related data communication.

Here, the controller may acquire second unique data including the vehicle charging state information from a battery related control device among the control devices in the vehicle, acquire second unique data including the vehicle driving record information from a driving record related control device among the control devices in the vehicle, and acquire second unique data including the time information and GPS information of the vehicle from a navigation related control device among the control devices in the vehicle.

As another example, when the controller acquires second unique data corresponding to a data communication start time from the second control device, the controller may acquire second unique data including DTC information, diagnosed control device information, time information and GPS information of the vehicle if approved data communication is vehicle diagnosis service related data communication.

Here, the controller may acquire second unique data including the DTC information of the vehicle from a wireless communication related control device among the control devices in the vehicle, acquire second unique data including the diagnosed control device information from the diagnosed control device among the control devices in the vehicle, and acquire second unique data including the time information and GPS information of the vehicle from a navigation related control device among the control devices in the vehicle.

As another example, when the controller acquires second unique data corresponding to a data communication start time from the second control device, the controller may acquire second unique data including checksum information about data finally downloaded at the data communication start time if approved data communication is music and video service related data communication.

Here, the controller may acquire second unique data including the checksum information about the finally downloaded data from a wireless communication related control device or an audio and video related control device among the control devices in the vehicle.

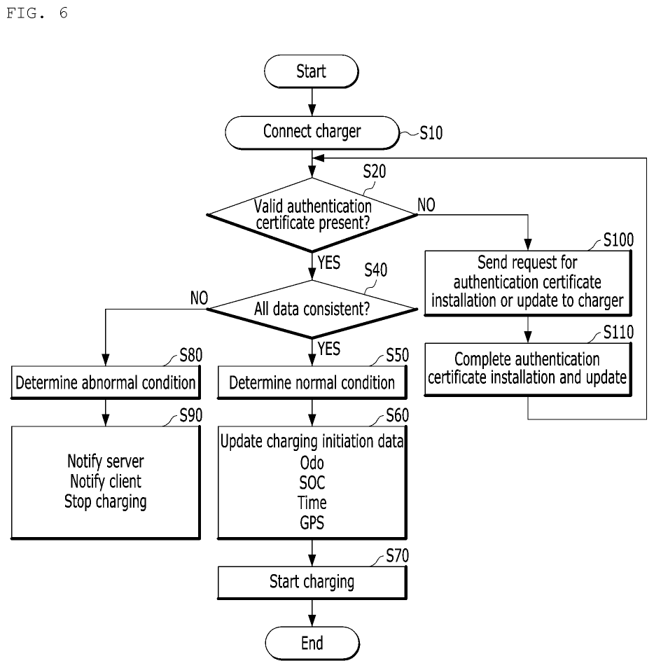

FIG. 6 is a flowchart for describing a personal information protection method of the personal information protection device for vehicles according to an aspect of the present disclosure and showing an aspect in which a personal information protecting process for performing a charging service is described.

That is, FIG. 6 shows an aspect for describing a personal information protection method of the personal information protection device for vehicles including the controller which determines approval of data communication of a charging control device which intends to perform data communication with an external charger.

As shown in FIG. 6, the controller may check whether a charging control device of a vehicle is connected to an external charger for data communication (S10).

In addition, the controller checks whether there is an authentication certificate related to a vehicle charging service when the charging control device of a vehicle is connected to the external charger for data communication (S20).

Subsequently, the controller extracts first unique data stored when previous last data communication is performed from the charging control device, extracts second unique data stored when previous last data communication is performed from a control device other than the charging control device and compares the first unique data with the second unique data when there is an authentication certificate (S30).

However, the controller may request update of an authentication certificate if the authentication certificate is not valid or request installation of a new authentication certificate if there is no authentication certificate (S100) and receive an updated or new authentication certificate from an external charging server and install the received authentication certificate (S110).

Here, the controller may extract first unique data including charging state information, driving record information, time information and GPS information of the vehicle.

For example, the charging state information of the vehicle may be first unique data acquired from a battery related control device among control devices other than the charging control device, the driving record information of the vehicle may be first unique data acquired from a driving record related control device among control devices other than the charging control device, and the time information and GPS information of the vehicle may be first unique data acquired from a navigation related control device among control devices other than the charging control device.

In addition, the controller may acquire charging state information of the vehicle stored when previous last data communication is performed from a battery related control device among control devices other than the charging control device, acquire driving record information of the vehicle stored when previous last data communication is performed from a driving record related control device among control devices other than the charging control device, acquire time information and GPS information of the vehicle stored when previous last data communication is performed from a navigation related control device among control devices other than the charging control device, and extract second unit data.

Then, the controller may check whether the extracted first unique data is consistent with the extracted second unit data (S40).

Thereafter, the controller may determine that the current state is a normal condition when the extracted first unique data is consistent with the extracted second unit data and determine approval of data communication of the charging control device (S50).

However, if all first unique data are not consistent with all second unique data, the controller may determine that the current state is an abnormal condition (S80), reject approval of data communication of the charging control device, generate an approval rejection notification message and transmit the approval rejection notification message to a previously designated entity (S90).

In addition, if the extracted first unique data includes a plurality of pieces of information, the controller may check whether all information included in the first unique data are consistent with all information included in second unique data corresponding thereto and determine approval of data communication of the charging control device when all information included in the first unique data are consistent with all information included in second unique data corresponding thereto.

Upon determination of approval of data communication of the charging control device, the controller may acquire second unique data from a control device other than the charging control device and update the first unique data of the charging control device on the basis of the acquired second unique data (S60).

Here, the controller may acquire second unique data corresponding to a data communication start time from a control device other than the charging control device upon determination of approval of data communication of the charging control device and update the first unique data of the charging control device on the basis of the acquired second unique data.

For example, the controller may acquire second unique data including charging state information, driving record information, time information and GPS information of the vehicle which correspond to the data communication start time.

Here, the charging state information of the vehicle may be acquired from a battery related control device among control devices other than the charging control device, the driving record information of the vehicle may be acquired from a driving record related control device among control devices other than the charging control device, and the time information and GPS information of the vehicle may be acquired from a navigation related control device among control devices other than the charging control device.

Subsequently, the controller may control the charging control device to perform data communication with an external charger to start charging when the first unique data has been updated (S70).

As described above, the system and/or method can compare first unique data stored in a control device which intends to perform data communication with an external entity when previous last data communication is performed with second unique data stored in another control device when previous last data communication is performed, determine approval of data communication of the control device if the first unique data is consistent with the second unique data, and update the first unique data of the control device on the basis of second unique data acquired from the other control device at a data communication start time, to thereby inhibit theft and replication of personal information in a vehicle.

In addition, the system and/or method can perform primary security verification of extracting first unique data and second unique data and secondary security verification of comparing the extracted first unique data and second unique data with each other to check whether they are consistent with each other when there is a valid authentication certificate for data communication, to thereby protect personal information in a vehicle safely.

Furthermore, the system and/or method can perform security verification for both internal control devices and external control devices by comparing first unique data extracted from a control device connected to an external entity through communication among control devices of a vehicle or an external control device connected to the vehicle through communication with second unique data extracted from another control device in the vehicle to check whether they are consistent with each other.

Moreover, the present system and/or method can extract and record different pieces of unique data according to service types for data communication, thereby allowing utilization of various vehicle services.

In addition, the present system and/or method can correctly extract second unique data from a control device without error by identifying the control device which provides first unique data on the basis of an identifier extracted from the first unique data, thereby improving reliability of security verification.

Furthermore, when first unique data includes a plurality of pieces of information, the system and/or method can determine approval of data communication of a control device if all information included in the first unique data are consistent with all information included in second unique data corresponding thereto, thereby protecting personal information in a vehicle safely.

Moreover, the system and/or method can reject approval of data communication of a control device if first unique data is not consistent with second unique data, generate an approval rejection notification message and transmit the approval rejection notification message to a previously designated entity, to thereby rapidly notify a server and a client that service utilization is blocked, providing user convenience for inhibition of theft and replication of personal information.

Further, considering the trend toward an increasing number of vehicle controllers connected to external infrastructure, such as a PnC controller, the system and/or method can provide a fundamental countermeasure against theft/replication of controllers.

Further, the system may be implemented without additional packages or parts.

In addition, the system and/or method can inhibit information from being taken according to signal capture by allocating one byte to a CAN signal and transmitting final storage information only when a new PnC service is started.

The method may be implemented as code readable by a computer and stored in a computer-readable recording medium. The computer-readable recording medium includes all kinds of recording devices in which data readable by computer systems is stored. Examples of the computer-readable recording medium include an HDD (Hard Disk Drive), an SSD (Solid State Drive), an SDD (Silicon Disk Drive), a ROM, a RAM, a CD-ROM, a magnetic tape, a floppy disk, an optical data storage device, and a medium realized in the form of carrier wave (e.g., transmission over the Internet).

What is claimed is:

1. A personal information protection device for vehicles, comprising:
a communication unit connected to control devices of a vehicle for communication; and
a controller configured to determine whether to approve data communication of a control device which intends to perform data communication with an outside device,
wherein the controller is further configured to:
extract first unique data stored when previous last data communication is performed from a first control device which intends to perform data communication with the outside device if the first control device is present among the control devices of the vehicle,
extract second unique data stored when previous last data communication is performed from a second control device other than the first control device,
determine approval of data communication of the first control device if the extracted first unique data is consistent with the extracted second unique data, and
update the first unique data of the first control device on the basis of second unique data acquired from the second control device at a data communication start time.

2. The personal information protection device according to claim 1, wherein, when the controller extracts the first unique data and the second unique data, the controller is configured to:
check whether the first control device which intends to perform data communication with the outside device is present among the control devices of the vehicle,
check whether there is an authentication certificate present for data communication if the first control device which intends to perform data communication with the outside device, and
extract the first unique data and the second unique data if the authentication certificate is present.

3. The personal information protection device according to claim 1, wherein, when the controller extracts the first unique data, the controller is configured to check a service type for data communication and extract the first unique data according to the checked service type.

4. The personal information protection device according to claim 3, wherein, when the controller extracts the first unique data according to the checked service type, the controller is configured to extract first unique data selected from among charging state information, driving record information, time information and global positioning system (GPS) information of the vehicle, when the service type is a vehicle charging service.

5. The personal information protection device according to claim 3, wherein, when the controller extracts the first unique data according to the checked service type, the controller is configured to extract first unique data selected from among diagnostic trouble codes (DTC) information, diagnosed control device information, time information and GPS information of the vehicle, when the service type is a vehicle diagnosis service.

6. The personal information protection device according to claim 3, wherein, when the controller extracts the first unique data according to the checked service type, the controller is configured to extract first unique data selected from among checksum information about data finally downloaded when previous last data communication is performed, when the service type is a music and video service.

7. The personal information protection device according to claim 1, wherein, when the controller extracts the second unique data, the controller is configured to identify a second control device which provides the first unique data upon extraction of the first unique data and extracts second unique data stored when previous last data communication is performed from the identified second control device.

8. The personal information protection device according to claim 1, wherein, when the controller determines approval of data communication of the first control device, the controller is configured to:
check whether all information included in the first unique data are consistent with all information included in second unique data corresponding thereto if the extracted first unique data includes a plurality of pieces of information, and
determine approval of data communication of the first control device when all information included in the first unique data are consistent with all information included in second unique data corresponding thereto.

9. The personal information protection device according to claim 1, wherein, when the controller updates the first unique data of the first control device, the controller is configured to:
acquire second unique data corresponding to a data communication start time from the second control device upon determination of approval of data communication of the first control device, and
update the first unique data of the first control device on the basis of the acquired second unique data.

10. The personal information protection device according to claim 9, wherein, when the controller acquires second unique data corresponding to a data communication start time from the second control device, the controller is configured to acquire second unique data selected from among charging state information, driving record information, time information and GPS information of the vehicle corresponding to the data communication start time, if the approved data communication is data communication related to a vehicle charging service.

11. The personal information protection device according to claim 9, wherein, when the controller acquires second unique data corresponding to a data communication start time from the second control device, the controller is configured to acquire second unique data selected from among DTC information, diagnosed control device information, time information and GPS information of the vehicle corresponding to the data communication start time, if the approved data communication is data communication related to a vehicle diagnosis service.

12. The personal information protection device according to claim 9, wherein, when the controller acquires second unique data corresponding to a data communication start time from the second control device, the controller is configured to acquire second unique data selected from among checksum information about data finally downloaded at the data communication start time, if the approved data communication is data communication related to a music and video service.

13. A personal information protection method of a personal information protection device for vehicles including a communication unit connected to control devices of a vehicle for communication, and a controller configured to determine whether to approve data communication of a control device which intends to perform data communication with an outside device, the personal information protection method comprising:
the controller checking whether a first control device which intends to perform data communication with the outside device is present among the control devices of the vehicle through the communication unit;
the controller extracting first unique data stored when previous last data communication is performed from the first control device when the first control device which intends to perform data communication with the outside device is present;
the controller extracting second unique data stored when previous last data communication is performed from a second control device other than the first control device;
the controller checking whether the extracted first unique data is consistent with the extracted second unique data;
the controller determining approval of data communication of the first control device if the extracted first unique data is consistent with the extracted second unique data;
the controller acquiring second unique data corresponding to a data communication start time from the second control device upon determination of approval of data communication of the first control device; and
the controller updating the first unique data of the first control device on the basis of the acquired second unique data.

14. The personal information protection method according to claim 13, wherein the extracting of the first unique data stored when previous last data communication is performed from the first control device comprises:
the controller checking whether the first control device which intends to perform data communication with the outside device is present among the control devices of the vehicle;
the controller checking whether there is an authentication certificate present for data communication if the first control device which intends to perform data communication with the outside device; and
the controller extracting the first unique data stored when previous last data communication is performed from the first control device if the authentication certificate is present.

15. The personal information protection method according to claim 13, wherein the extracting of the first unique data stored when previous last data communication is performed from the first control device comprises:
checking a service type for data communication; and
extracting the first unique data according to the checked service type.

16. The personal information protection method according to claim 13, wherein the determining of approval of data communication of the first control device when the extracted first unique data is consistent with the extracted second unique data comprises checking whether all information included in the first unique data are consistent with all information included in second unique data corresponding thereto if the extracted first unique data includes a plurality of pieces of information, and determining approval of data communication of the first control device when all information included in the first unique data are consistent with all information included in second unique data corresponding thereto.

17. The personal information protection method according to claim 13, wherein the updating of the first unique data of the first control device on the basis of the acquired second unique data comprises acquiring second unique data corresponding to a data communication start time from the second control device upon determination of approval of data communication of the first control device, and updating the first unique data of the first control device on the basis of the acquired second unique data.

18. A personal information protection method of a personal information protection device for vehicles including a controller configured to determine whether to approve data communication of a charging control device which intends to perform data communication with an external charger, the personal information protection method comprising:
the controller checking whether the charging control device of a vehicle is connected to an external charger for data communication;
the controller checking whether there is an authentication certificate related to a vehicle charging service when the charging control device of the vehicle is connected to an external charger for data communication;
the controller extracting first unique data stored when previous last data communication is performed from the charging control device when the authentication certificate is present;
the controller extracting second unique data stored when previous last data communication is performed from a control device other than the charging control device;
the controller checking whether the extracted first unique data is consistent with the extracted second unique data;
the controller determining that the current state is a normal condition and determining approval of data communication of the charging control device if the extracted first unique data is consistent with the extracted second unique data;
the controller acquiring second unique data from the control device other than the charging control device upon determination of approval of data communication of the charging control device;
the controller updating the first unique data of the charging control device on the basis of the acquired second unique data; and
the controller controlling the charging control device to perform data communication with the external charger to start charging when the first unique data has been updated.

19. The personal information protection method according to claim 18, wherein the extracting of the first unique data comprises extracting first unique data selected from among charging state information, driving record information, time information and GPS information of the vehicle, and
the extracting of the second unique data comprises extracting the second unique data by acquiring charging state information of the vehicle stored when previous last data communication is performed from a battery related control device among control devices other than the charging control device, acquiring driving record information of the vehicle stored when previous last data communication is performed from a driving record related control device among control devices other than the charging control device, and acquiring time information and GPS information of the vehicle stored when previous last data communication is performed from a navigation related control device among control devices other than the charging control device.

20. A vehicle comprising the personal information protection device of claim 1.
